(19) United States
(12) Patent Application Publication
(10) Pub. No.: US 2025/0007954 A1
(43) Pub. Date: Jan. 2, 2025

(54) Management System for a Cloud Platform

(71) Applicant: Dell Products L.P., Round Rock, TX (US)

(72) Inventors: Vinay Sawal, Fremont, CA (US); Viswanath Ponnuru, Bangalore (IN); Sumanth Vidyadhara, Bangalore (IN)

(21) Appl. No.: 18/343,629

(22) Filed: Jun. 28, 2023

(51) Int. Cl. H04L 9/40

(52) U.S. Cl. CPC H04L 63/20

(57) ABSTRACT

A system can receive, from a remote computer of remote computers, inventory data representative of an inventory, wherein the inventory data indicates that the remote computer is configured to interact with other remote computers of the remote computers according to a compute express link protocol. The system can receive, from the remote computer, a request to onboard the remote computer, wherein the request adheres to a defined security protocol and data model architecture, and wherein the system is configured to remotely manage the remote computers as part of a hybrid cloud platform that comprises the remote computers. The system can authenticate the remote computer based on the request and according to the defined security protocol and data model architecture. The system can remotely monitor hardware resources of the remote computers based on workload configuration map data representative of a workload configuration map of the remote computers.

### BACKGROUND

Computer systems can be managed remotely.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can receive, from a remote computer of remote computers, inventory data representative of an inventory, wherein the inventory data indicates that the remote computer is configured to interact with other remote computers of the remote computers according to a compute express link protocol. The system can receive, from the remote computer, a request to onboard the remote computer, wherein the request adheres to a defined security protocol and data model architecture, and wherein the system is configured to remotely manage the remote computers as part of a hybrid cloud platform that comprises the remote computers. The system can authenticate the remote computer based on the request and according to the defined security protocol and data model architecture. The system can remotely monitor hardware resources of the remote computers based on workload configuration map data representative of a workload configuration map of the remote computers.

An example method can comprise receiving, by a system comprising a processor, an inventory from a remote computer of remote computers, wherein the inventory indicates that the remote computer is configured to interact with other remote computers of the remote computers according to a compute express link protocol. The method can further comprise receiving, by the system, a request from the remote computer to onboard the remote computer, wherein the system is configured to remotely manage the remote computers as part of a hybrid cloud platform that comprises the remote computers. The method can further comprise authenticating, by the system, the remote computer based on the request. The method can further comprise remotely monitoring, by the system, hardware resources of the remote computers based on a workload configuration map of the remote computers.

An example non-transitory computer-readable medium can comprise instructions that, in response to execution, cause a system comprising a processor to perform operations. These operations can comprise receiving an inventory from a remote computer of remote computers, wherein the inventory indicates that the remote computer is configured to pool resources with other remote computers of the remote computers. These operations can further comprise receiving a request from the remote computer to onboard the remote computer, wherein the system is configured to remotely manage the remote computers as part of a hybrid cloud platform that comprises the remote computers. These operations can further comprise authenticating the remote computer based on the request. These operations can further comprise remotely monitoring hardware resources of the remote computers based on a workload configuration map of the remote computers.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate a management system for a cloud platform, in accordance with an embodiment of this disclosure;

FIG. 2 illustrates another example system architecture that can facilitate a management system for a cloud platform, in accordance with an embodiment of this disclosure;

FIG. 3 illustrates another example system architecture that can facilitate a management system for a cloud platform, in accordance with an embodiment of this disclosure;

FIG. 4 illustrates another example system architecture that can facilitate a management system for a cloud platform, in accordance with an embodiment of this disclosure;

FIG. 5 illustrates an example signal flow that can facilitate a management system for a cloud platform, in accordance with an embodiment of this disclosure;

FIG. 6 illustrates another example signal flow that can facilitate a management system for a cloud platform, in accordance with an embodiment of this disclosure;

FIG. 7 illustrates another example process flow that can facilitate a management system for a cloud platform, in accordance with an embodiment of this disclosure.

FIG. 8 illustrates another example process flow that can facilitate a management system for a cloud platform, in accordance with an embodiment of this disclosure;

FIG. 9 illustrates another example process flow that can facilitate a management system for a cloud platform, in accordance with an embodiment of this disclosure;

FIG. 10 illustrates another example process flow that can facilitate a management system for a cloud platform, in accordance with an embodiment of this disclosure;

FIG. 11 illustrates an example block diagram of a computer operable to execute an embodiment of this disclosure.

### DETAILED DESCRIPTION

### Overview

A compute express link protocol can comprise is a high-speed interconnect standard that facilitates an efficient link between a computer processor and platform subsystems.

A compute express link protocol can be implemented to facilitate creating a protocol overlay to support a whole host of components that can be attached to provide high-bandwidth, low-latency connectivity between compute, accelerators, memory devices, and smart input/output (I/O) devices (including smart network interface cards (NICs)).

A problem with prior approaches to monitoring and configuration management of compute express link-enabled devices can relate to it being difficult to implement this monitoring and configuration management in a cloud platform because of multiple host system interconnects in the cloud platform.

The present techniques can be implemented to facilitate a monitoring and configuration management-enabled management application programming interface (API) from a cloud platform console for simple and easy cloud management tasks.

The present techniques can be implemented to facilitate compute express link-based API resource management using connectivity module APIs of a hybrid cloud management platform to facilitate a compute offload integrated solution stack.

The present techniques can be implemented to facilitate a compute express link I/O device abstraction and management interface integrated into connectivity module client APIs for seamless cloud management operations.

The present techniques can be implemented to facilitate establishing authenticated security mechanisms between connectivity module clients and hardware accelerators using a security model and data model protocol for secure communication and sensitive data transfers.

The present techniques can be implemented to facilitate providing workload-specific hardware accelerator (e.g., graphics processing unit (GPU), central processing unit (CPU), security engine) optimized configuration maps.

### Example Architectures

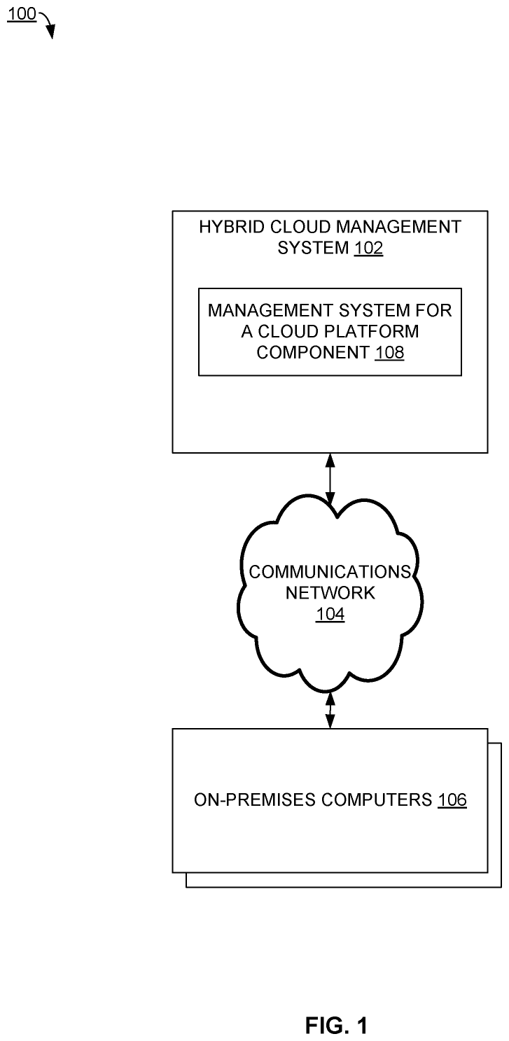

FIG. 1 illustrates an example system architecture 100 that can facilitate a management system for a cloud platform, in accordance with an embodiment of this disclosure.

System architecture 100 comprises hybrid cloud management system 102, communications network 104, and on-premises computers 106. In turn, hybrid cloud management system 102 comprises management system for a cloud platform component 108.

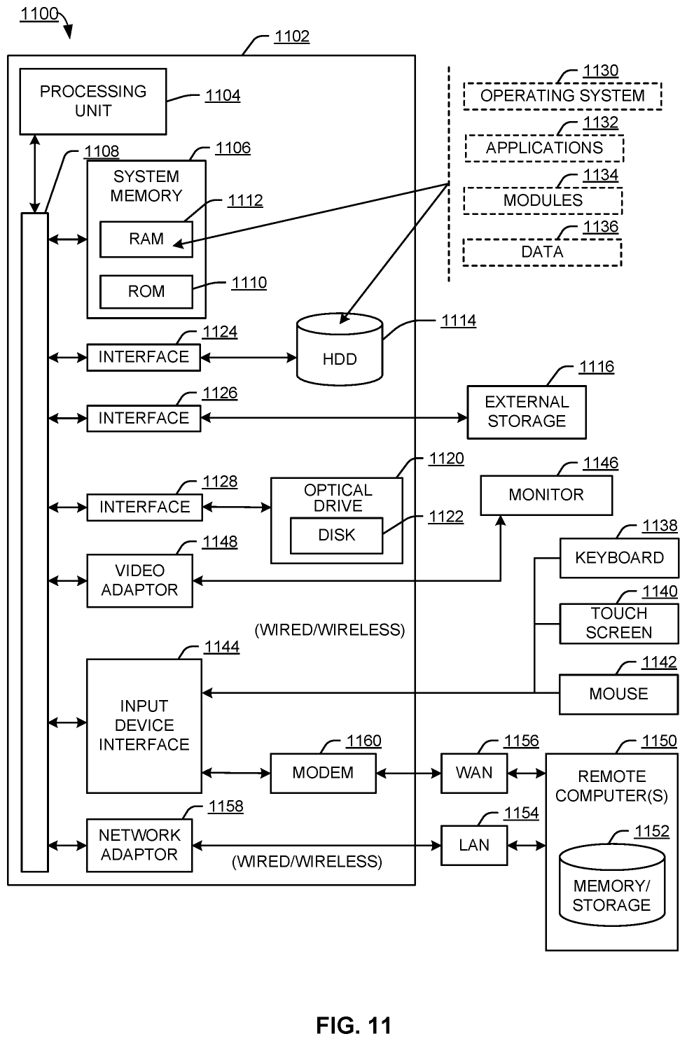

Each of hybrid cloud management system 102 and/or on-premises computers 106 can be implemented with part(s) of computing environment 1100 of FIG. 11. Communications network 104 can comprise a computer communications network, such as the Internet.

On-premises computers 106 can comprise one or more computers that are installed on a customer's premises and are (or are to be) managed by hybrid cloud management system 102. As part of that, hybrid cloud management system 102 can create and manage shared resources from computers of on-premises computers, such as according to a compute express link protocol.

A compute express link protocol can generally facilitate high-speed and high-capacity processor-to-device and processor-to-memory connections. Shared resources can include such resources as compute, graphics processing, data processing, and security.

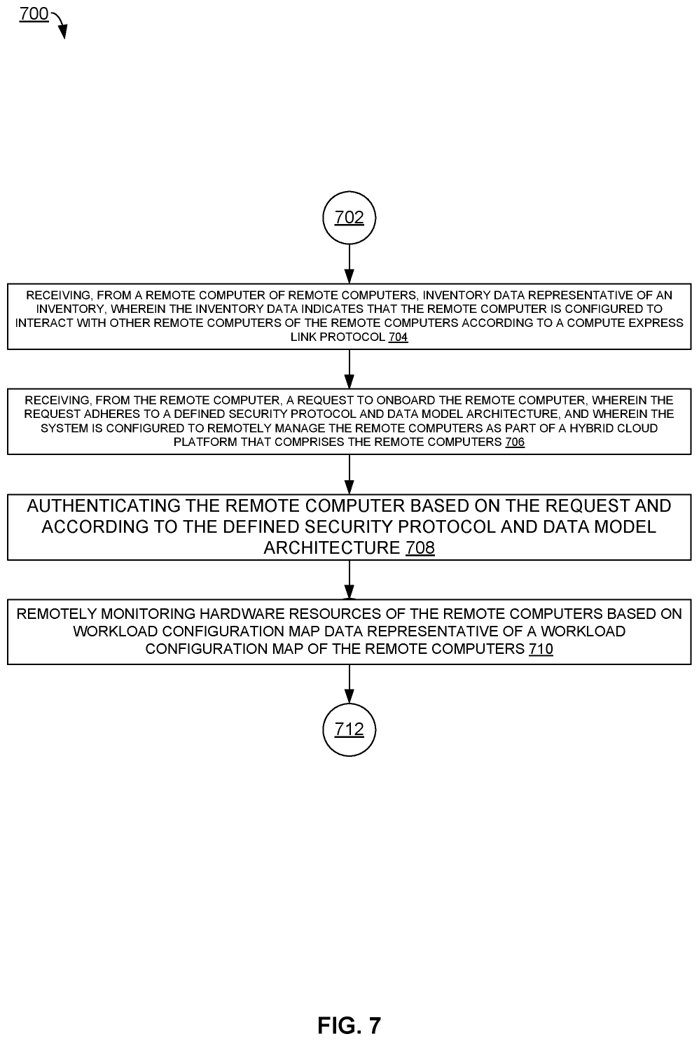

In some examples, management system for a cloud platform component 108 can implement part(s) of the process flows of FIGS. 7-10 to implement management system for a cloud platform.

It can be appreciated that system architecture 100 is one example system architecture for management system for a cloud platform, and that there can be other system architectures that facilitate a management system for a cloud platform.

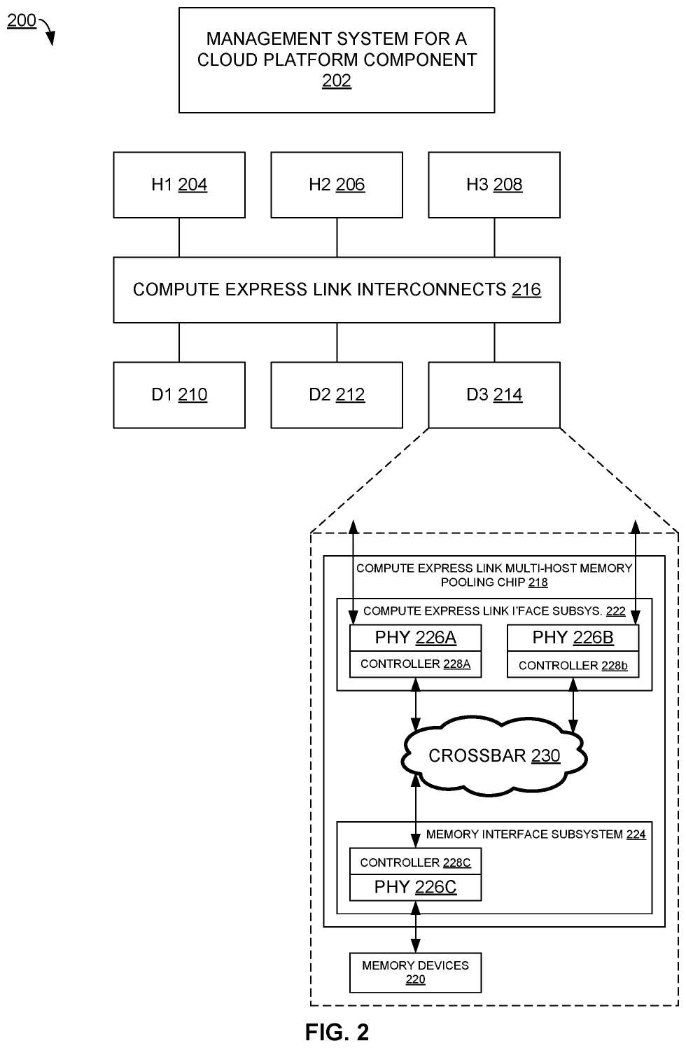

FIG. 2 illustrates another example system architecture 200 that can facilitate a management system for a cloud platform, in accordance with an embodiment of this disclosure. In some examples, part(s) of system architecture 200 can be used to implement part(s) of system architecture 100 of FIG. 1.

System architecture 200 comprises management system for a cloud platform component 202 (which can be similar to management system for a cloud platform component 108 of FIG. 1), host H1 204, host H2 206, host H3 208, device D1 210, device D2 212, device D3 214, compute express link interconnects 216, compute express link multi-host memory pooling chip 218, memory devices 220 (which can be double data rate (DDR) memory devices), compute express link interface subsystem 222, memory interface subsystem 224 (which can be a DDR memory interface), physical layer (PHY) 226A, PHY 226B, PHY 226C, controller 228A, controller 228B, controller 228C, and crossbar 230.

Compute express link interconnects 216 can create an overlay of H1 204, H2 206, H3 208, D1 210, D2 212, and/or D3 214, to support high-bandwidth and low-latency connectivity between devices such as compute, accelerators, memory devices, and/or smart I/O devices. Management system for a cloud platform component 202 can manage this connectivity.

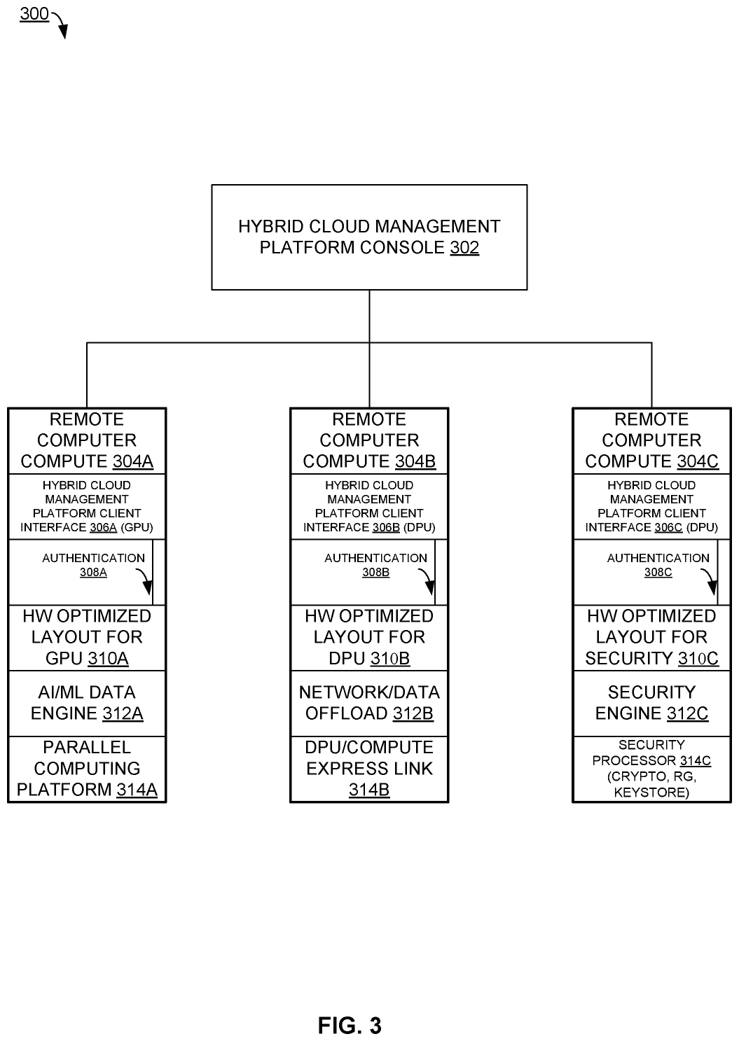

FIG. 3 illustrates another example system architecture 300 that can facilitate a management system for a cloud platform, in accordance with an embodiment of this disclosure. In some examples, part(s) of system architecture 300 can be used to implement part(s) of system architecture 100 of FIG. 1.

System architecture 300 comprises hybrid cloud management platform console 302 (which can be part of management system for a cloud platform component 108 of FIG. 1), remote computer compute 304A, hybrid cloud management platform client interface 306A (graphics processing unit (GPU)), authentication 308A (which can comprise authentication according to a security protocol and data model protocol), hardware (HW) optimized layout for GPU 310A, artificial intelligence/machine learning (AI/ML) data engine 312A, parallel computing platform 314A, remote computer compute 304B, hybrid cloud management platform client interface 306B (data processing unit (DPU)), authentication 308B, HW optimized layout for DPU 310B, network/data offload 312B, DPU/compute express link 314B, remote computer compute 304C, hybrid cloud management platform client interface 306C (DPU), authentication 308C. HW optimized layout for security 310C, security engine 312C, and security processor 314C (cryptography, keystore).

One computer can comprise remote computer compute 304A, hybrid cloud management platform client interface 306A, authentication 308A, HW optimized layout for GPU 310A, AI/ML data engine 312A, and parallel computing platform 314A. Another computer can comprise remote computer compute 304B, hybrid cloud management platform client interface 306B, authentication 308B, HW optimized layout for DPU 310B, network/data offload 312B, and DPU/compute express link 314B. A third computer can comprise remote computer compute 304C, hybrid cloud management platform client interface 306C, authentication 308C. HW optimized layout for security 310C, security engine 312C, and security processor 314C.

Hybrid cloud management platform console 302 can manage resources across multiple computers (e.g., parallel computing platform 314A, DPU/compute express link 314B, and security processor 314C).

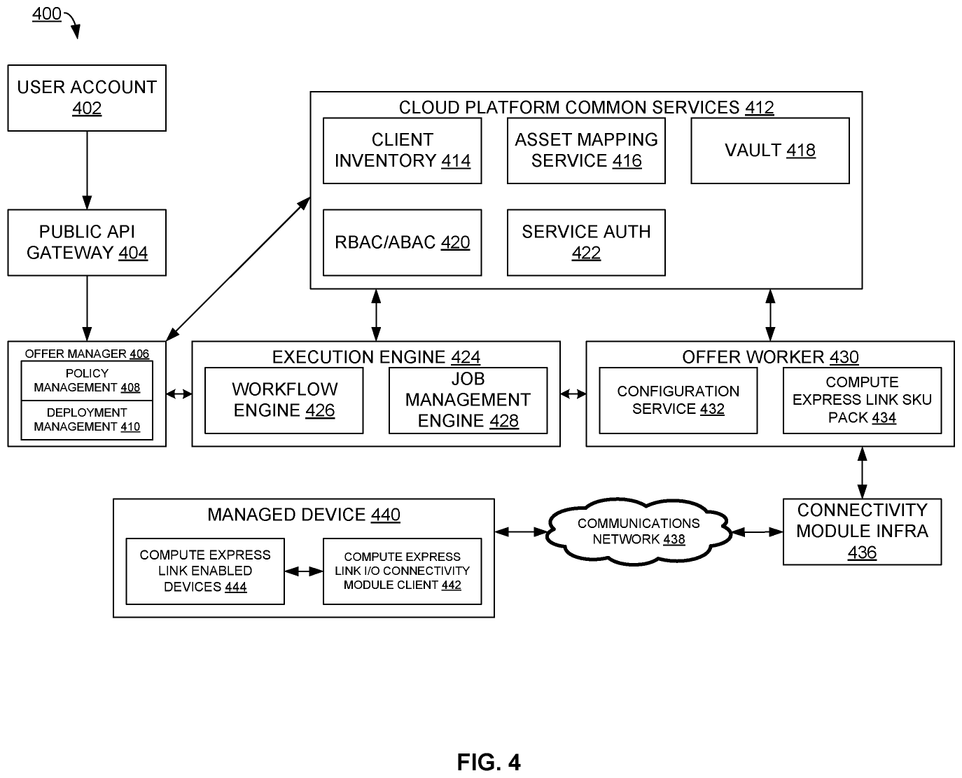

FIG. 4 illustrates another example system architecture 400 that can facilitate a management system for a cloud platform, in accordance with an embodiment of this disclosure. In some examples, part(s) of system architecture 400 can be used to implement part(s) of system architecture 100 of FIG. 1.

System architecture 400 comprises user account 402, public application programming interface (API) gateway 404, offer manager 406 (which comprises policy management 408 and deployment management 410), cloud platform common services 412 (which comprises client inventory 414, asset mapping service 416, vault 418, role-based access control/attribute-based access control (RBAC/ABAC) 420, and service authorization 422), execution engine 424 (which comprises workflow engine 426 and job management engine 428), offer worker 430 (which comprises configuration service 432 and compute express link stock keeping unit (SKU) pack 434), connectivity module 436, communications network 438, and managed device 440 (compute express link i/o connectivity module client 442 and compute express link enabled devices 444).

In system architecture 400, user account 402 can subscribe to a hybrid cloud management service that comprises managed device 440, and have a shared resource created that includes a resource of managed device 440.

In some examples, respective message busses can connect offer manager 406 and execution engine 424, and execution engine 424 and offer worker 430.

User account 402 can comprise a user account associated with a customer (or consumer) that is used by a cloud service provider for authentication and authorization. Public API gateway 404 can comprise an API gateway to route API requests from outside to an appropriate service. Offer manager 406 can provide subscription-specific management functions. Policy management 408 can comprise a service to manage policies associated with each client. Deployment management 410 can comprise a service to manage equipment deployed at the client location.

Cloud platform common services 412 can comprise common services across all subscriptions/offers. Client inventory 414 can comprise a database of equipment located at a client data center. Asset mapping service 416 can comprise a service that provides a mapping between a client's subscription-id and a client inventory at the client data center. Vault 418 can comprise storage to store secrets (e.g., user IDs and passwords, and/or certificates). RBAC/ABAC 420 can comprise an access control engine for role-based and attribute-based access. Service authorization 422 can comprise a function to provide service-to-service authentication.

Execution engine 424 can comprise an orchestration engine to manage workflow execution. Workflow engine 426 can comprise an engine that manages client/user-initiated workflows. Job management engine 428 can comprise a service to manage asynchronous jobs.

Offer worker 430 can perform subscription-specific services. Configuration service 432 can manage desired state configuration on each device/equipment. compute express link SKU pack 434 can comprise vendor-specific drivers to manage CXL devices at a client location.

Connectivity module 436 can comprise infrastructure to provide connectivity between a cloud and managed devices. Managed device 440 can comprise a device at a client location that is being managed by a cloud services platform.

### Example Signal Flows

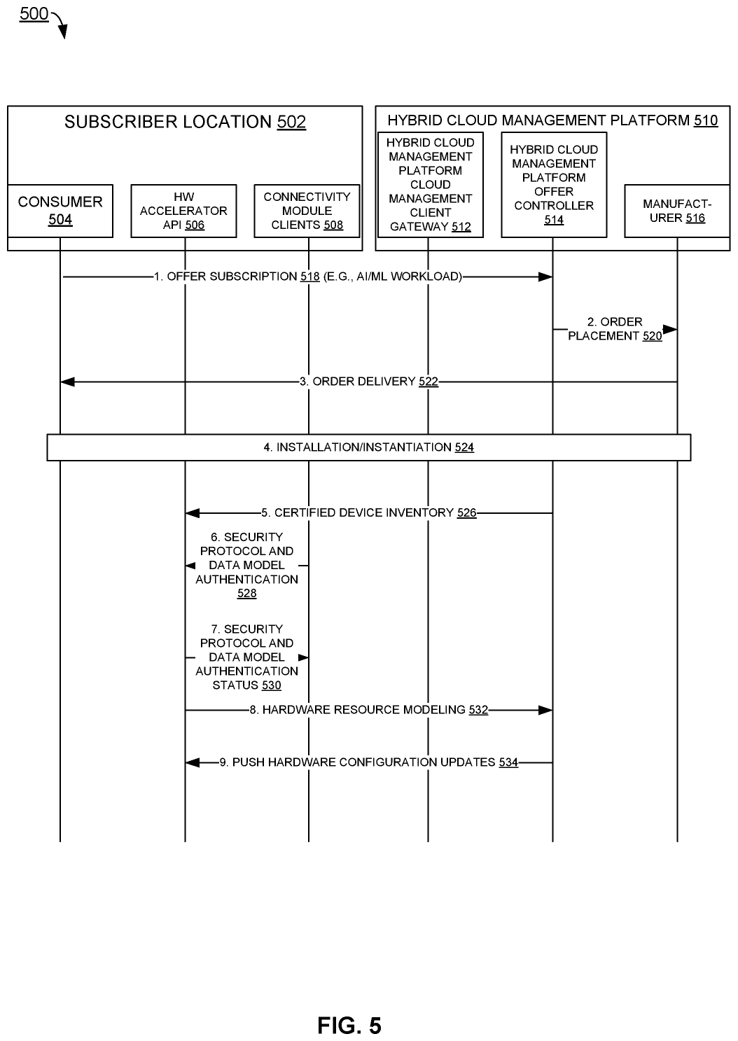

FIG. 5 illustrates an example signal flow 500 that can facilitate a management system for a cloud platform, in accordance with an embodiment of this disclosure. In some examples, one or more embodiments of signal flow 500 can be implemented by management system for a cloud platform component 108 of FIG. 1, or computing environment 1100 of FIG. 11.

Signal flow 500 comprises signals sent between and within subscriber location 502 (which comprises consumer 504, HW accelerator API 506, and connectivity module clients 508) and hybrid cloud management platform 510 (which comprises hybrid cloud management platform connectivity module client gateway 512, hybrid cloud management platform offer controller 514, and manufacturer 516).

The example signals of signal flow 500 are as follows. Hybrid cloud management platform offer controller 514 sends offer subscription 518 (e.g., AI/ML workload) to consumer 504. Consumer 504 sends order placement 520 to manufacturer 516. Manufacturer 516 sends order delivery 522 to consumer 504 (which can comprise physically transferring a computer manufactured by manufacturer 516 to an on-premises site of consumer 504).

Installation/instantiation 524 is performed. This can comprise installing hardware at a physical location of consumer 504, performing device initialization, and establishing a secure connection with hybrid cloud management platform 510.

Hybrid cloud management platform offer controller 514 sends certified device inventory 526 to connectivity module clients 508. Connectivity module clients 508 sends security protocol and data model authentication 528 to HW accelerator API 506. HW accelerator API 506 sends security protocol and data model authentication status 530 to connectivity module clients 508.

HW accelerator API 506 sends hardware resource modeling 532 to hybrid cloud management platform offer controller 514. Hybrid cloud management platform offer controller 514 sends push hardware configuration updates 534 to HW accelerator API 506.

In this manner, consumer 504 can subscribe to a hybrid cloud management platform that incorporates a shared devices according to a compute express link protocol.

In general, 518-522 can comprise offering subscription suggestions based on workload types (e.g., artificial intelligence/machine learning (AI/ML), scientific, security engine). In general, 526-530 can comprise validating and authenticating endpoint devices using security protocol data model specifications to verify hybrid cloud management platform-approved devices that participate in hybrid cloud management platform device configurations. The security policies can be governed by an offer controller of the hybrid cloud management platform. In general, 532-534 can comprise remote hardware resource monitoring via a hybrid cloud management platform connectivity module to check against workload configurations, and provide a notification to take further action in a case of changes to hardware settings.

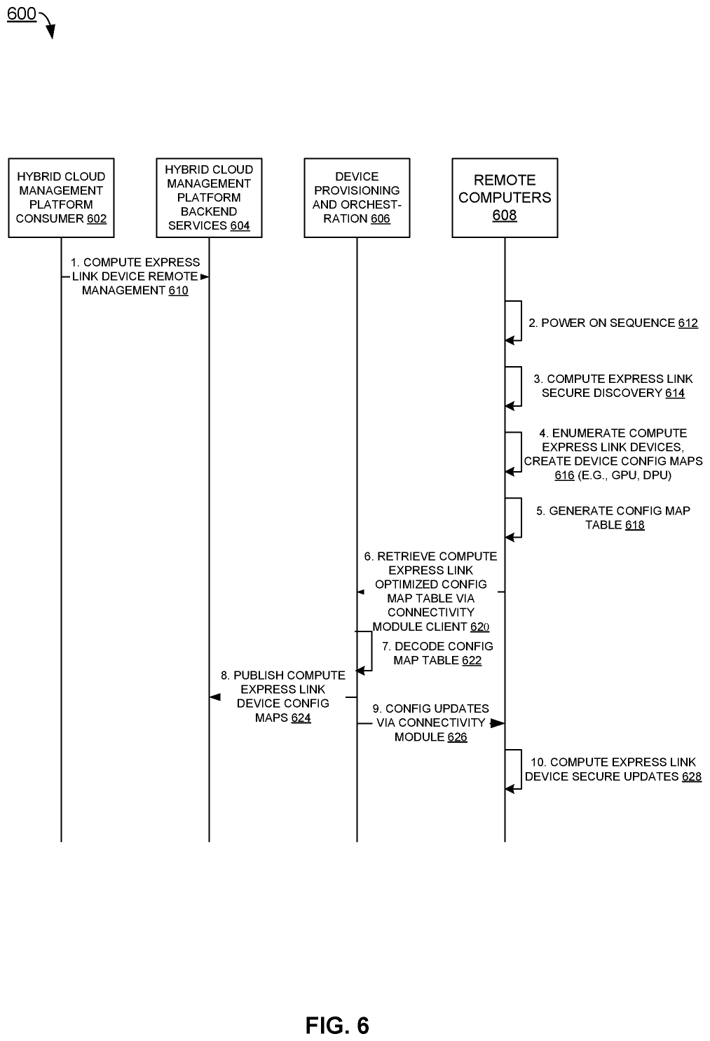

FIG. 6 illustrates another example signal flow 600 that can facilitate a management system for a cloud platform, in accordance with an embodiment of this disclosure. In some examples, one or more embodiments of signal flow 600 can be implemented by management system for a cloud platform component 108 of FIG. 1, or computing environment 1100 of FIG. 11.

Signal flow 600 comprises signals sent between hybrid cloud management platform consumer 602, hybrid cloud management platform backend services 604, device provisioning and orchestration 606, and remote computers 608.

The example signals of signal flow 600 are as follows. Hybrid cloud management platform consumer 602 sends compute express link device remote management 610 to hybrid cloud management platform backend services 604. Remote computers 608 performs power on sequence 612. Remote computers 608 performs compute express link secure discovery 614. This secure discovery can be performed according to a security protocol and data model protocol, and/or a management control transport protocol.

Remote computers 608 performs enumerate compute express link devices, create device config maps (sometimes referred to as ConfigMaps) 616 (e.g., GPU, DPU). Remote computers 608 performs generate config map table 618. This can comprise generating a JavaScript Object Notation (JSON) format encoded binary mapping.

Remote computers 608 sends retrieve compute express link optimized config map table via connectivity module client 620 to device provisioning and orchestration 606. Device provisioning and orchestration 606 performs decode config map table 622. This can comprise decoding the config map table from a JSON format.

Device provisioning and orchestration 606 sends publish compute express link device config maps 624 to hybrid cloud management platform backend services 604. Device provisioning and orchestration 606 sends config updates via connectivity module 626 to remote computers 608. Remote computers 608 performs compute express link device secure updates 628. These updates can be performed according to a security protocol and data model protocol, a CMA, and/or a management control transport protocol.

In this manner, hybrid cloud management platform consumer 602 can subscribe to a hybrid cloud management platform that incorporates shared resources of remote computers 608.

### Example Process Flows

FIG. 7 illustrates an example process flow 700 for management system for a cloud platform, in accordance with an embodiment of this disclosure. In some examples, one or more embodiments of process flow 700 can be implemented by management system for a cloud platform component 108 of FIG. 1, or computing environment 1100 of FIG. 11.

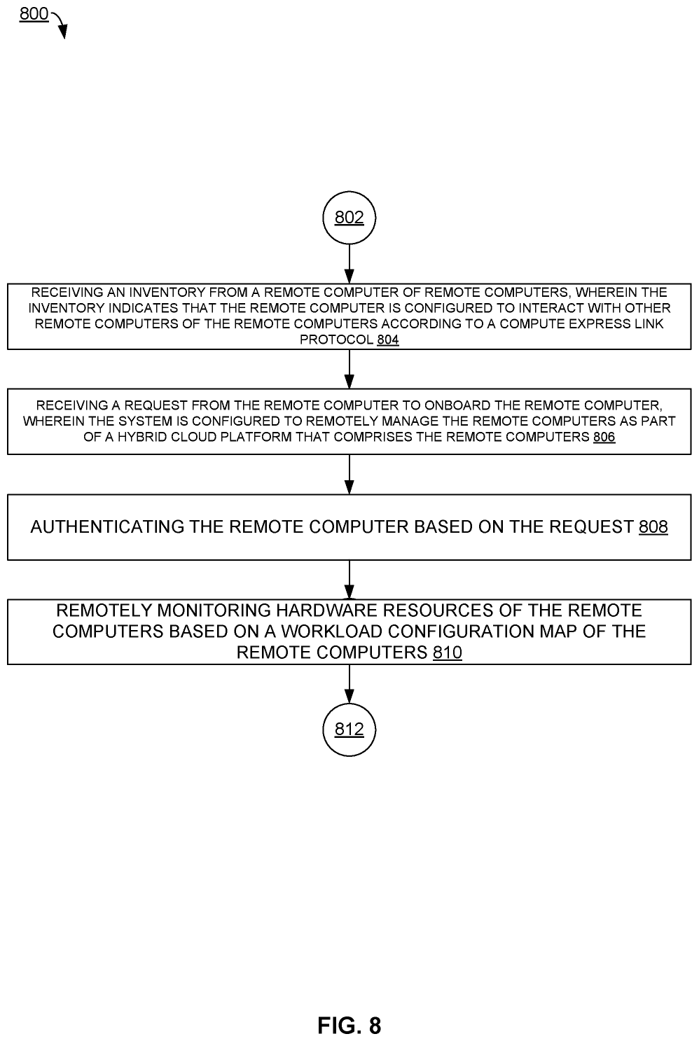

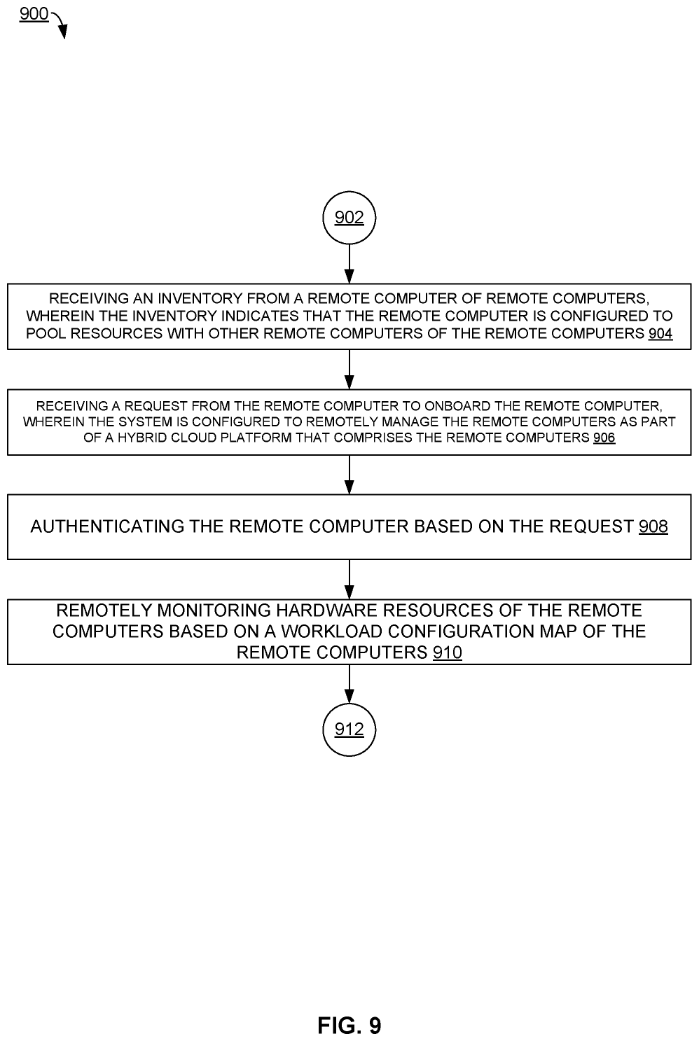

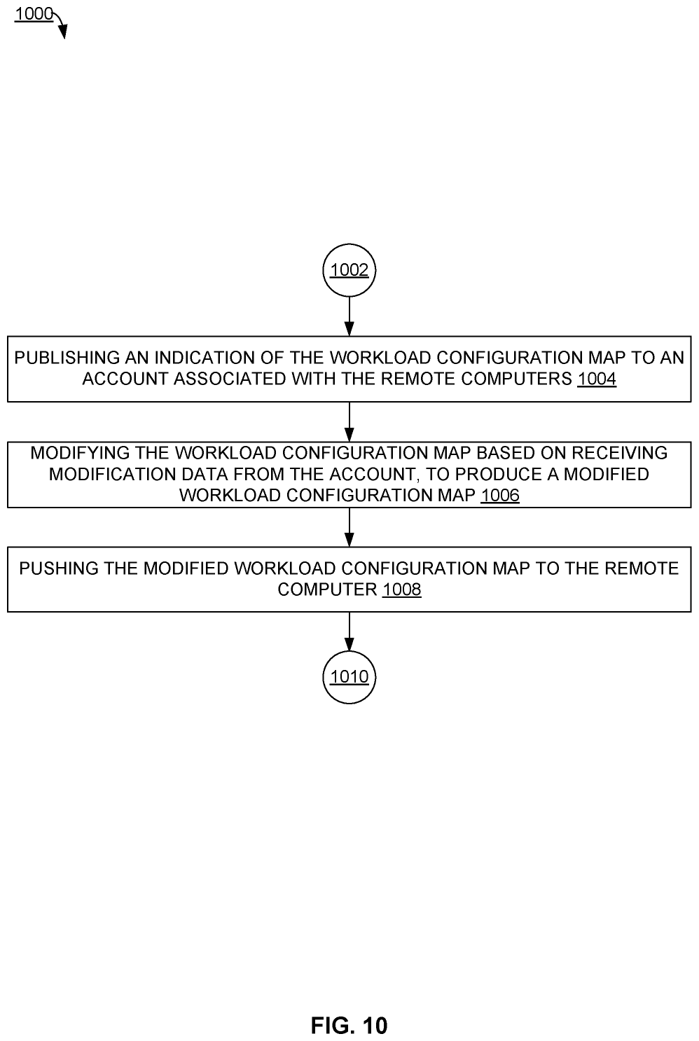

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 800 of FIG. 8, process flow 900 of FIG. 9, and/or process flow 1000 of FIG. 10.

Process flow 700 begins with 702, and moves to operation 704.

Operation 704 depicts receiving, from a remote computer of remote computers, inventory data representative of an inventory, wherein the inventory data indicates that the remote computer is configured to interact with other remote computers of the remote computers according to a compute express link protocol. In some examples, this can be similar to certified device inventory 526 of FIG. 5.

After operation 704, process flow 700 moves to operation 706.

Operation 706 depicts receiving, from the remote computer, a request to onboard the remote computer, wherein the request adheres to a defined security protocol and data model architecture, and wherein the system is configured to remotely manage the remote computers as part of a hybrid cloud platform that comprises the remote computers. In some examples, this can be similar to security protocol and data model authentication 528 of FIG. 5.

After operation 706, process flow 700 moves to operation 708.

Operation 708 depicts authenticating the remote computer based on the request and according to the defined security protocol and data model architecture. In some examples, this can be similar to security protocol and data model authentication status 530 of FIG. 5.

After operation 708, process flow 700 moves to operation 710.

Operation 710 depicts remotely monitoring hardware resources of the remote computers based on workload configuration map data representative of a workload configuration map of the remote computers. In some examples, this can be similar to hardware resource modeling 532 of FIG. 5.

In some examples, operation 710 comprises pushing a hardware configuration change update to the remote computer. In some examples, this can be similar to push hardware configuration updates 534 of FIG. 5.

In some examples, the workload configuration map data representative of the workload configuration map is first workload configuration map data representative of a first workload configuration map, and operation 710 comprises generating second workload configuration map data representative of a second workload configuration map based on a workload of the remote computers. That is, new hardware configuration change updates can be pushed to a remote computer.

In some examples, the workload configuration map comprises usage of hardware acceleration. Hardware acceleration can be similar to DPU/compute express link 314B of FIG. 3.

In some examples, the workload configuration map comprises usage of a graphics processing unit. Usage of a GPU can be similar to parallel computing platform 314A of FIG. 3.

In some examples, the workload configuration map comprises usage of a central processing unit.

In some examples, the workload configuration map comprises usage of a security engine. Usage of a security processor can be similar to security processor 314C of FIG. 3.

After operation 710, process flow 700 moves to 712, where process flow 700 ends.

FIG. 8 illustrates an example process flow 800 for management system for a cloud platform, in accordance with an embodiment of this disclosure. In some examples, one or more embodiments of process flow 800 can be implemented by management system for a cloud platform component 108 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 700 of FIG. 7, process flow 900 of FIG. 9, and/or process flow 1000 of FIG. 10.

Process flow 800 begins with 802, and moves to operation 804.

Operation 804 depicts receiving an inventory from a remote computer of remote computers, wherein the inventory indicates that the remote computer is configured to interact with other remote computers of the remote computers according to a compute express link protocol. In some examples, operation 804 can be implemented in a similar manner as operation 704 of FIG. 7.

After operation 804, process flow 800 moves to operation 806.

Operation 806 depicts receiving a request from the remote computer to onboard the remote computer, wherein the system is configured to remotely manage the remote computers as part of a hybrid cloud platform that comprises the remote computers. In some examples, operation 806 can be implemented in a similar manner as operation 706 of FIG. 7.

In some examples, the request adheres to a specified security protocol and data model architecture. That is, establishing authenticated security mechanisms between connectivity module clients can be performed according to a security protocol and data model protocol.

In some examples, receiving the request from the remote computer to onboard the remote computer is performed in response to the remote computer being powered on. This can be similar to power on sequence 612 of FIG. 6.

After operation 806, process flow 800 moves to operation 808.

Operation 808 depicts authenticating the remote computer based on the request. In some examples, operation 808 can be implemented in a similar manner as operation 708 of FIG. 7.

In some examples, the authenticating is performed according to a specified security protocol and data model architecture. That is, establishing authenticated security mechanisms between connectivity module clients and/or hardware accelerators can be performed according to a security protocol and data model protocol.

After operation 808, process flow 800 moves to operation 810.

Operation 810 depicts remotely monitoring hardware resources of the remote computers based on a workload configuration map of the remote computers. In some examples, operation 810 can be implemented in a similar manner as operation 710 of FIG. 7.

In some examples, operation 810 comprises receiving an indication of the workload configuration map of the remote computer from the remote computer, and wherein the remotely monitoring of the hardware resources of for remote computers is performed based on the indication of the workload configuration map. This can be similar to retrieve compute express link optimized config map table via connectivity module client 620 of FIG. 6.

In some examples, operation 810 comprises decoding the indication of the workload configuration map to produce a decoded workload configuration map, wherein the remotely monitoring of the hardware resources of for remote computers is performed based on the decoded workload configuration map. In some examples, the indication of the workload configuration map comprises a JavaScript object notation format, and wherein the decoded workload configuration map comprises a second format that differs from the JavaScript object notation format. This can be similar to decode config map table 622 of FIG. 6.

In some examples, the indication of the workload configuration map comprises an encoded binary indication of the workload configuration map.

After operation 810, process flow 800 moves to 812, where process flow 800 ends.

FIG. 9 illustrates an example process flow 900 for management system for a cloud platform, in accordance with an embodiment of this disclosure. In some examples, one or more embodiments of process flow 900 can be implemented by management system for a cloud platform component 108 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 700 of FIG. 7, process flow 800 of FIG. 8, and/or process flow 1000 of FIG. 10.

Process flow 900 begins with 902, and moves to operation 904.

Operation 904 depicts receiving an inventory from a remote computer of remote computers, wherein the inventory indicates that the remote computer is configured to pool resources with other remote computers of the remote computers. In some examples, operation 904 can be implemented in a similar manner as operation 704 of FIG. 7.

In some examples, the inventory indicates that the remote computer is configured to pool the resources with the other remote computers according to a compute express link protocol.

After operation 904, process flow 900 moves to operation 906.

Operation 906 depicts receiving a request from the remote computer to onboard the remote computer, wherein the system is configured to remotely manage the remote computers as part of a hybrid cloud platform that comprises the remote computers. In some examples, operation 906 can be implemented in a similar manner as operation 706 of FIG. 7.

In some examples, the request adheres to a security protocol and data model architecture.

After operation 906, process flow 900 moves to operation 908.

Operation 908 depicts authenticating the remote computer based on the request. In some examples, operation 908 can be implemented in a similar manner as operation 708 of FIG. 7.

In some examples, the authenticating is performed according to a security protocol and data model architecture.

After operation 908, process flow 900 moves to operation 910.

Operation 910 depicts remotely monitoring hardware resources of the remote computers based on a workload configuration map of the remote computers. In some examples, operation 910 can be implemented in a similar manner as operation 710 of FIG. 7.

After operation 910, process flow 900 moves to 912, where process flow 900 ends.

FIG. 10 illustrates an example process flow 1000 for management system for a cloud platform, in accordance with an embodiment of this disclosure. In some examples, one or more embodiments of process flow 1000 can be implemented by management system for a cloud platform component 108 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 700 of FIG. 7, process flow 800 of FIG. 8, and/or process flow 900 of FIG. 9.

Process flow 1000 begins with 1002, and moves to operation 1004.

Operation 1004 depicts publishing an indication of the workload configuration map to an account associated with the remote computers. In some examples, this can be similar to publish compute express link device config maps 624 of FIG. 6.

After operation 1004, process flow 1000 moves to operation 1006.

Operation 1006 depicts modifying the workload configuration map based on receiving modification data from the account, to produce a modified workload configuration map.

After operation 1006, process flow 1000 moves to operation 1008. In some examples, this can be similar to config updates via connectivity module 626 of FIG. 6.

Operation 1008 depicts pushing the modified workload configuration map to the remote computer. In some examples, this can be similar to compute express link device remote management 610 of FIG. 6.

After operation 1004, process flow 1000 moves to 1010, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of hybrid cloud management system 102, and/or on-premises computers 106 of FIG. 1.

In some examples, computing environment 1100 can implement one or more embodiments of the process flows of FIGS. 7-10 to facilitate a management system for a cloud platform.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multiprocessor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory coupled to the processor, comprising instructions that, in response to execution by the processor, cause the system to perform operations, comprising:
receiving, from a remote computer of remote computers, inventory data representative of an inventory, wherein the inventory data indicates that the remote computer is configured to interact with other remote computers of the remote computers according to a compute express link protocol;
receiving, from the remote computer, a request to onboard the remote computer, wherein the request adheres to a defined security protocol and data model architecture, and wherein the system is configured to remotely manage the remote computers as part of a hybrid cloud platform that comprises the remote computers;
authenticating the remote computer based on the request and according to the defined security protocol and data model architecture; and
remotely monitoring hardware resources of the remote computers based on workload configuration map data representative of a workload configuration map of the remote computers.

2. The system of claim 1, wherein the operations further comprise:
pushing a hardware configuration change update to the remote computer.

3. The system of claim 1, wherein the workload configuration map data representative of the workload configuration map is first workload configuration map data representative of a first workload configuration map, and wherein the operations further comprise:
generating second workload configuration map data representative of a second workload configuration map based on a workload of the remote computers.

4. The system of claim 1, wherein the workload configuration map comprises usage of hardware acceleration.

5. The system of claim 1, wherein the workload configuration map comprises usage of a graphics processing unit.

6. The system of claim 1, wherein the workload configuration map comprises usage of a central processing unit.

7. The system of claim 1, wherein the workload configuration map comprises usage of a security engine.

8. A method, comprising:
receiving, by a system comprising a processor, an inventory from a remote computer of remote computers, wherein the inventory indicates that the remote computer is configured to interact with other remote computers of the remote computers according to a compute express link protocol;
receiving, by the system, a request from the remote computer to onboard the remote computer, wherein the system is configured to remotely manage the remote computers as part of a hybrid cloud platform that comprises the remote computers;
authenticating, by the system, the remote computer based on the request; and
remotely monitoring, by the system, hardware resources of the remote computers based on a workload configuration map of the remote computers.

9. The method of claim 8, wherein the request adheres to a specified security protocol and data model architecture.

10. The method of claim 9, wherein the authenticating is performed according to the specified security protocol and data model architecture.

11. The method of claim 8, wherein the receiving the request from the remote computer to onboard the remote computer is performed in response to the remote computer being powered on.

12. The method of claim 8, further comprising:
receiving, by the system, an indication of the workload configuration map of the remote computer from the remote computer, and wherein the remotely monitoring of the hardware resources of for remote computers is performed based on the indication of the workload configuration map.

13. The method of claim 12, further comprising:
decoding, by the system, the indication of the workload configuration map to produce a decoded workload configuration map, wherein the remotely monitoring of the hardware resources of for remote computers is performed based on the decoded workload configuration map.

14. The method of claim 13, wherein the indication of the workload configuration map comprises a JavaScript object notation format, and wherein the decoded workload configuration map comprises a second format that differs from the Javascript object notation format.

15. The method of claim 12, wherein the indication of the workload configuration map comprises an encoded binary indication of the workload configuration map.

16. A non-transitory computer-readable medium comprising instructions that, in response to execution, cause a system comprising a processor to perform operations, comprising:
receiving an inventory from a remote computer of remote computers, wherein the inventory indicates that the remote computer is configured to pool resources with other remote computers of the remote computers;
receiving a request from the remote computer to onboard the remote computer, wherein the system is configured to remotely manage the remote computers as part of a hybrid cloud platform that comprises the remote computers;
authenticating the remote computer based on the request; and
remotely monitoring hardware resources of the remote computers based on a workload configuration map of the remote computers.

17. The non-transitory computer-readable medium of claim 16, wherein the inventory indicates that the remote computer is configured to pool the resources with the other remote computers according to a compute express link protocol.

18. The non-transitory computer-readable medium of claim 16, wherein the operations further comprise:
publishing an indication of the workload configuration map to an account associated with the remote computers;
modifying the workload configuration map based on receiving modification data from the account, to produce a modified workload configuration map; and
pushing the modified workload configuration map to the remote computer.

19. The non-transitory computer-readable medium of claim 16, wherein the request adheres to a security protocol and data model architecture.

20. The non-transitory computer-readable medium of claim 19, wherein the authenticating is performed according to the security protocol and data model architecture.
